(19) United States
(12) Patent Application Publication
(10) Pub. No.: US 2015/0142571 A1
(43) Pub. Date: May 21, 2015

(54) SYSTEM AND METHOD FOR INCREASING THE LIKELIHOOD OF USERS REVIEWING ADVERTISEMENTS

(71) Applicant: Wojciech Moczydlowski, Forest Hills, NY (US)

(72) Inventor: Wojciech Moczydlowski, Forest Hills, NY (US)

(73) Assignee: GOOGLE INC., Mountain View, CA (US)

(21) Appl. No.: 13/113,982

(22) Filed: May 23, 2011

(51) Int. Cl. G06Q 30/00; G06Q 30/02; G06F 17/30

(52) U.S. Cl. CPC G06Q 30/0261; G06Q 30/0277; G06F 17/3053
USPC 705/14.58; 705/14.73

(57) ABSTRACT

A system and machine-implemented method for displaying an advertisement in a supplemental display area comprising a first supplemental content display region and a second supplemental content display region for concurrent display with a primary content display area on a user device, including identifying the first supplemental content display region and the second supplemental content display region, obtaining an advertisement information, transmitting the advertisement information for display in the first supplemental content display region, obtaining a non-advertisement information, transmitting the non-advertisement information for display in the second supplemental content display region.

### BACKGROUND

Techniques are known within the art for displaying a plurality of advertisements, such as short text-based advertisements, image-based advertisements, and video-based advertisements, at predetermined locations on a webpage. Over time users begin to pay increasingly less attention to such webpage-based advertisements, to the point where they are often ignored by users. If users end up ignoring such advertisements, they may miss opportunities relevant to their interests. A common technique employed by advertisers to attract the attention of users (and also to compete with other advertisements) is to make advertisements more visually stimulating, such as by using images, animation, video, and/or audio. However, these forms of advertisements generally require more data to be delivered to users, which may increase expense and delay for delivering and displaying such advertisements.

### SUMMARY

The disclosed subject matter relates to a machine-implemented method for displaying an advertisement in a supplemental display region of a display comprising providing a primary content display region, providing a first supplemental content display region and a second supplemental content display region, both of which are co-located within the primary content display region, obtaining advertisement information, providing the advertisement information for display in the first supplemental content display region, obtaining non-advertisement information, and providing the non-advertisement information for display in the second supplemental content display region, wherein the advertisement information and non-advertisement information are displayed concurrently.

The disclosed subject matter further relates to a system for displaying advertisements. The system comprises an advertisement database storing a plurality of pieces of advertisement information, one or more processors, and a machine-readable medium comprising instructions stored therein. When the processors execute the operations, the processors perform operations comprising: receiving a first request from a user device for a first piece of supplemental content and a second request for a second piece of supplemental content for concurrent display within a supplemental display area and with a primary content display area on the user device, providing an advertisement information obtained from the advertisement database to the user device in response to the first request, and providing a non-advertisement information to the user device in response to the second request.

The disclosed subject matter also relates to a machine-readable medium comprising instructions stored therein, which when executed by a machine, cause the machine to perform operations including receiving a first request associated with a first supplemental content display region and a second request associated with a second supplemental content display region for concurrent display within a supplemental display area and with a primary content display area on a user device, obtaining an advertisement information, providing the advertisement information to the user device in response to the first request, obtaining a non-advertisement information, and providing the non-advertisement information to the user device in response to the second request.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several aspects of the disclosed subject matter are set forth in the following figures.

FIG. 1 illustrates an exemplary architecture diagram for the disclosed techniques for displaying advertisements.

FIG. 2 illustrates an example of display contents 200 displayed on display unit 150 of user device 145.

FIG. 3 illustrates a process 300 by which advertisements are displayed.

FIG. 4 conceptually illustrates an electronic system 300 with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

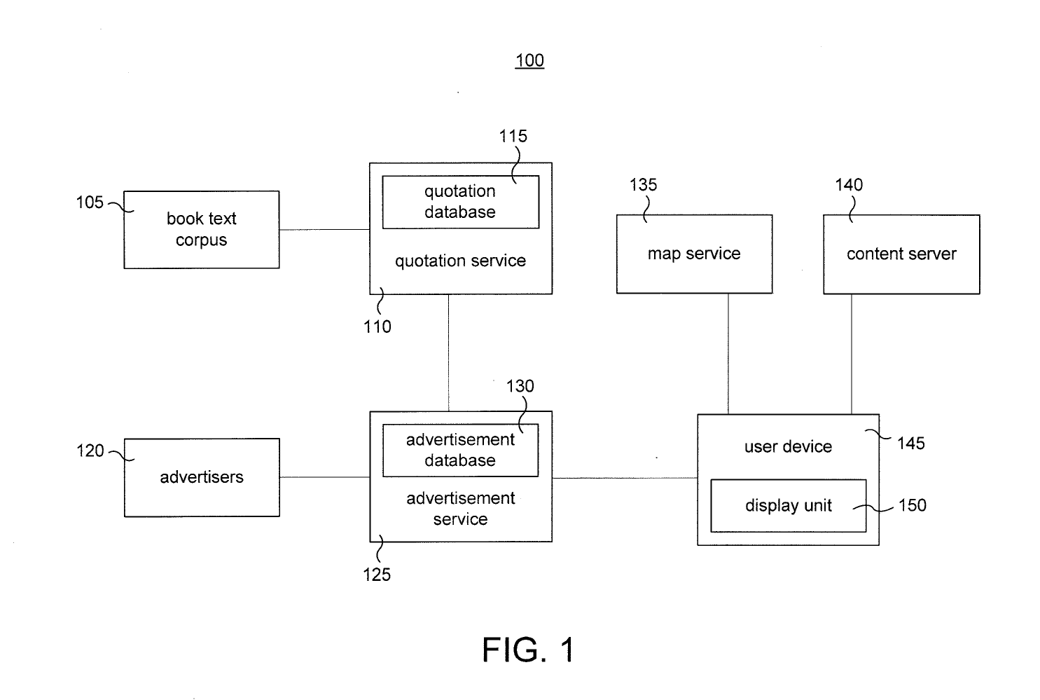

FIG. 1 illustrates an exemplary architecture diagram for the disclosed techniques for displaying advertisements. User device 145 is a network-connected device configured to retrieve content from content server 140 for display on display unit 150 included in user device 145. In an aspect of the disclosed subject matter, content server 140 executes a web server program responsive to HTTP requests for content issued by user device 145, and user device 145 executes a web browser program which issues the HTTP requests and converts content received from content server 140 responsive to those requests for display on display unit 150. In an aspect of the disclosed subject matter, rather than retrieve content from content server 140, user device 145 may also obtain content from map service 135 for display on display unit 150, such as an interactive map application which allows for searching for points of interest and selection of particular geographical areas for display on display unit 150.

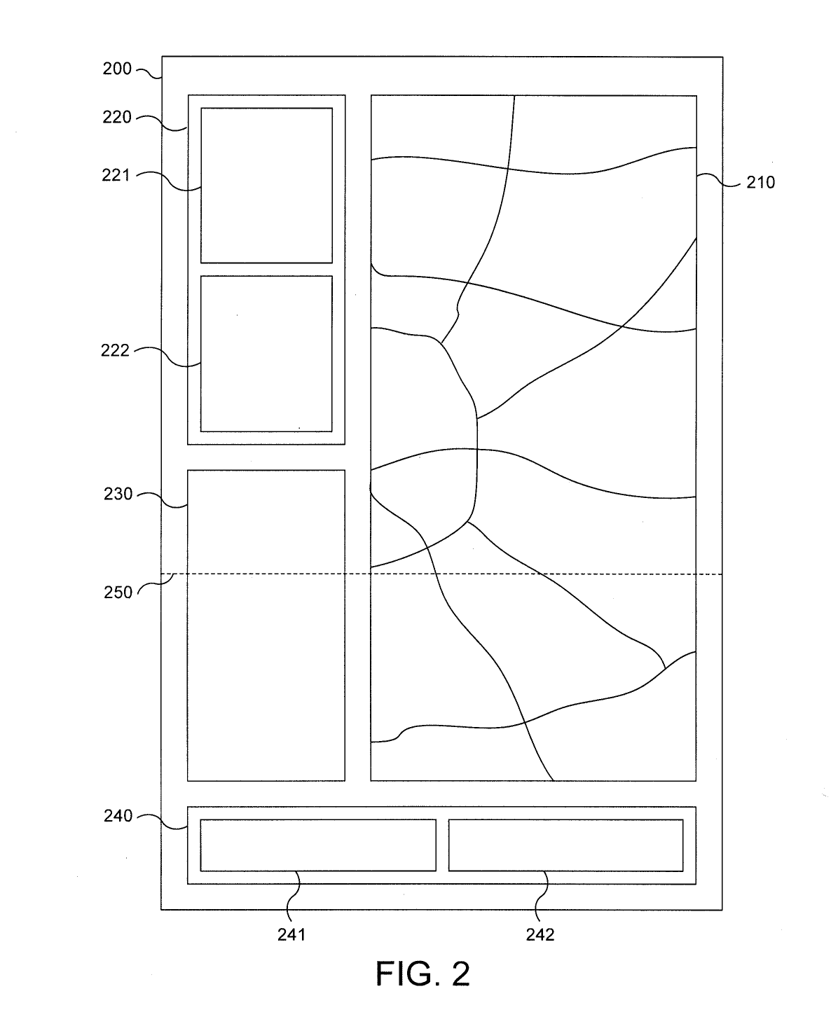

In an aspect of the disclosed subject matter, the content obtained by user device 145 may include a supplemental display area indicating one or more areas for displaying advertisements, with those areas collectively comprising regions for displaying two or more supplemental content display regions (see, for example, supplemental display area 220 and supplemental content display regions 221 and 222 illustrated in FIG. 2). Info′illation included in the content for these regions cause a program executing on user device, such as a web browser application, to contact advertisement service 125 with information relating to the supplemental content display regions specified by the content, and obtain supplemental content information, such as advertisement information, from advertisement service 125 for display in each of the supplemental content display regions on display unit 150.

In an aspect of the disclosed subject matter, advertisement service 125 includes an advertisement database 130 which stores advertisements and data relating to the advertisements. Advertisers 120 provide advertisements for storage in advertisement database 130, and additional information describing each advertisement such as keywords or categories relevant to displaying an advertisement. By providing advertisement data to user device 145, which renders the advertisement on display unit 150, it may be considered that advertising service 125 has displayed the advertisement on display unit 150. Such advertisements may be text-based (typically including hypertext links, such that when a displayed advertisement is selected by a user, a web browser application is directed to a website relating to the advertisement), but also may comprise, for example, images, animations, and/or videos. In an aspect of the disclosed subject matter, advertisement service 125 obtains information regarding the content, such as a document identifier, including the portions indicating the supplemental content display regions. In such an aspect, advertisement service 125 is able to provide content-aware advertising, in conjunction with the advertisement data stored in advertisement database 130, to identify and present advertisements related to the content, in order to provide advertisements which are presumably more closely related to the interests of a user requesting the content.

In addition to displaying advertisements, supplemental content display regions may also be used to display non-advertisement data. In an aspect of the disclosed subject matter, advertisement service 125 is also configured to obtain non-advertisement information, such as textual quotations from quotation service 110, instead of advertisement information, for display in one or more of the supplemental content display regions corresponding to a piece of content. By displaying non-advertisement information, hopefully of interest to a user of user device 145, users may be encouraged to more frequently review supplemental content display regions for information of interest, thereby increasing the likelihood that a user will not ignore advertisements displayed in the supplemental content display regions, whether an advertisement concurrently displayed with the non-advertisement information or advertisements displayed in supplemental display areas for other content in the future. In an aspect of the disclosed subject matter, advertisement service 125 performs content-aware selection of non-advertisement information to identify and present non-advertisement information related to the content, in order to display non-advertisement information which is presumably more closely related to the interests of a user requesting the content.

To provide textual quotations to advertisement service 125, quotation service 110 includes a quotation database 115 containing textual quotations. In an aspect of the disclosed subject matter, quotations stored in quotation database 115 are obtained from book text corpus 105. In an aspect of the disclosed subject matter, an supplemental content display region displaying a non-advertisement textual quotation is hyperlinked to a webpage related to the source of the quotation, such as a book included in book text corpus 105. In an aspect of the disclosed subject matter, text segments that satisfy “reasonable quote” conditions are extracted from book text corpus 105, and filtering is performed to remove text segments containing abusive content. In an aspect of the disclosed subject matter, quotes may simply be randomly selected from book text corpus 105. In an aspect of the disclosed subject matter, clickstream information (e.g., when a hyperlink for a quote is followed) is obtained from user device 145 and used to rank and select quotes. In an aspect of the disclosed subject matter, quotations are selected from quotation database 115 based on their relevance to the piece of content retrieved from content server 140. This relevance may be determined, for example, based on words included in the quotations as they relate to the content, or based on information regarding the source of the quote, such as a subject or category of a book. In an aspect of the disclosed subject matter, the comparative performance (e.g., “click-through” events reported by user device 145) of advertisements when displayed concurrently with particular quotes may be used to rank and select quotes that appear to be of greater interest to users.

Additionally, although book text corpus 105 is illustrated as an example source for textual quotations, other sources may be used in conjunction with or instead of books, such as, but not limited to, movie quotes, newsworthy quotes, celebrity quotes, political quotes, and other media.

In an aspect of the disclosed subject matter, user-specific options may be recorded with advertisement service 125 to affect the use of non-advertisement information. For example, a user may choose to opt out of displaying non-advertisement information in lieu of advertisements. As another example, the user may register particular areas or topics of interest from which non-advertisement information, such as quotes, should be selected. Also, a user may choose other specified sources of non-advertisement information to be displayed in a supplemental content display region, such as, although not limited to, an RSS feed (which may provide news of interest to the user), a stream of social networking posts (such as a Twitter feed), or a stream of images from an online photo album.

In an aspect of the disclosed subject matter not illustrated in FIG. 1, advertisement information and non-advertisement information may be obtained by content server 140, which incorporates this data into content provided to user device 145.

In an aspect of the disclosed subject matter, user device 145 may execute a program that has supplemental content display region for display on display unit 150 (e.g., a program which displays advertisements for generating revenue for the publisher of the program). In such an aspect, the program may directly request display data for the supplemental content display regions from advertisement service 125, without issuing a related request for content from content server 140.

In an aspect of the disclosed subject matter, whereas an advertisement may be selected in favor of advertisements that are most similar to the content in which an advertisement display region is included, in contrast non-advertisement information, such as a textual quotation, may be selected in favor of pieces of non-advertisement information that are most dissimilar to the content and/or the advertisement information. This presumably provides a non-advertisement information which is more unexpected or interesting to a user of user device 145, so as to better encourage ongoing viewing of supplemental display areas. Machine learning techniques used for categorizing advertisements, and vector-based correlation techniques for finding advertisements or clusters of advertisements that correlate to content may be adapted for use with non-advertisement information (e.g., by identifying a quotation or cluster of quotations with the lowest, rather than the highest, correlation).

In an aspect of the disclosed subject matter, a supplemental content display region, such as a supplemental content display region displaying a non-advertisement textual quotation, may be periodically updated with new advertisement or non-advertisement information in order to provide a more dynamic and attractive presentation in the supplemental display area, whereby content of an supplemental content display region is periodically replaced with new content. Either a “pull” (e.g., initiated by user device 145) or a “push” (e.g., initiated by advertisement service 125) operation may be performed in order to update the supplemental content display region.

FIG. 2 illustrates an example of display contents 200 displayed on display unit 150 of user device 145. A number of elements are concurrently displayed as part of display contents 200. Primary content display area 210 displays content retrieved from map service 135 or content server 140. FIG. 2 illustrates an example in which a graphical map obtained from map service 135 is displayed within primary content display area 210. Those skilled in the art understand that many different types of media or content, such as, but not limited to, text, images, and video, may be displayed in primary content display area 210. Additionally, primary content display area 210 may display content which is interactive with a user making use of user device 146. Examples of such interactive content include, but are not limited to, hyperlinks, text input fields, and movable and zoomable map displays. Another primary content display area 230 is included in the display contents 200, and may contain similar content as described for primary content display area 210. Primary content display areas 310 and 330 may also be considered to be included within a single primary content display area.

Display contents 200 also includes supplemental display area 220. In contrast to the information obtained for and displayed in primary content display areas 310 and 330, the information for supplemental display area 220 is not obtained from map service 135 or content server 140. Instead, user device 145 obtains information for display in supplemental display area 220 from advertisement service 125 (although in some aspects of the disclosed subject matter, user device 145 may obtain information indirectly via map service 135 or content server 140, which serve to relay such information from advertisement service 125). Supplemental display area 220 includes first supplemental content display region 221 and second supplemental display region 222. Supplemental display regions 221 and 222 are often utilized for displaying advertisement information. Such advertisement information may include, but is not limited to, text-based advertisements, image-based advertisements, animated or video advertisements, and mixtures thereof. Often, user device 145 is configured to respond to user interaction with a supplemental display region displaying advertisement information by directing the user to a further information for a product and/or service associated with the advertisement information.

Additionally, supplemental display regions 221 and 222 may also be used to display non-advertisement information such as, but not limited to, text, images, animation or video, and mixtures thereof. Thus, user device 145 may concurrently display on display unit 150 advertisement information in first supplemental display region 221 and non-advertisement information in second supplemental display region 222, or vice versa.

Display contents 200, as illustrated in FIG. 2, further includes a second supplemental display area 240, comprising third supplemental display region 241 and fourth supplemental display region 242.

Due to limited area for display unit 150, and depending on the size of display contents 200, not all of display contents 200 may be visible at the same time. In FIG. 2, display boundary 250 defines an extent of the viewable area of display contents 200, in which the portion of display contents 200 above display boundary 250 is visible. By any of a number of mechanisms well known in the art, such as a scrollbar or touch-sensitive scrolling, the portion of display contents 200 below the illustrated display boundary can also be made visible on display unit 150. In some cases, only a portion of display contents might be scrollable. In some aspects of the disclosed subject matter, information for non-visible elements of display contents 200, such as display area 240 located below display boundary 250, may not be retrieved and/or displayed until they are made visible in display unit 150.

In an aspect of the disclosed subject matter, primary content display area 210 may be used to display a map of a geographic region, provided by map service 135, and non-advertisement information is selected from pieces of non-advertisement information identified as relevant to the region displayed in primary content display area. In this manner, interesting information is presented to users that is relevant to what they are reviewing via map service 135.

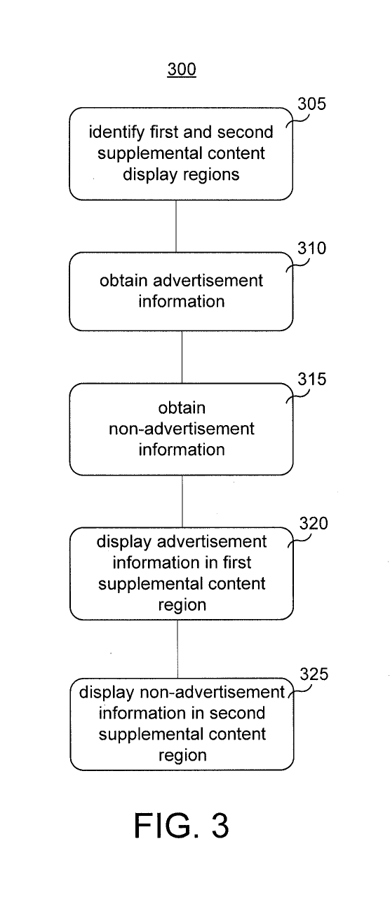

FIG. 3 illustrates a process 300 by which advertisements are displayed. At step 305, advertisement service 125 identifies first and second supplemental content display region for concurrent display with a primary content display area on display unit 150 of user device 145, such as two supplemental content display regions included in a supplemental display area on a single webpage.

At step 310, advertisement service 125 obtains an advertisement information, such as, but not limited to, a text-based advertisement. In an aspect of the disclosed subject matter, the obtained advertisement may instead be image, video, and/or audio-based as well. As discussed above, the obtained advertisement information may be selected based on the content obtained from content server 140, such as the content of the primary content display area.

At step 315, advertisement service 125 obtains a non-advertisement information, such as, but not limited to, a textual quotation from quotation service 110, which selects the textual quotation from quotation database 115. As discussed above, in some aspects of the disclosed subject matter, textual quotations may be drawn from other sources, such as an RSS or social networking feed. In an aspect of the disclosed subject matter, the obtained non-advertisement information may instead be image, video, and/or audio-based as well. In an aspect of the disclosed subject matter, the obtained non-advertisement is selected based on what is displayed in the primary content display area and/or in the displayed advertisement information.

At step 320, the advertisement information obtained in step 310 is displayed by advertisement service 125 in the first supplemental content display region on display unit 150 by providing the advertising information to user device 145 (either directly or via content server 140). At step 325, the non-advertisement information obtained in step 315 is displayed by advertisement service 125 in the second supplemental content display region on display unit 150 by providing the non-advertisement information to user device 145 (either directly or via content server 140). As a result, the advertisement information and non-advertisement information are displayed together in a supplemental display area concurrent with the display of primary content information on display unit 150 of user device 145.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software inventions can be implemented as sub-parts of a larger program while remaining distinct software inventions. In some implementations, multiple software inventions can also be implemented as separate programs. Finally, any combination of separate programs that together implement a software invention described here is within the scope of the invention. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

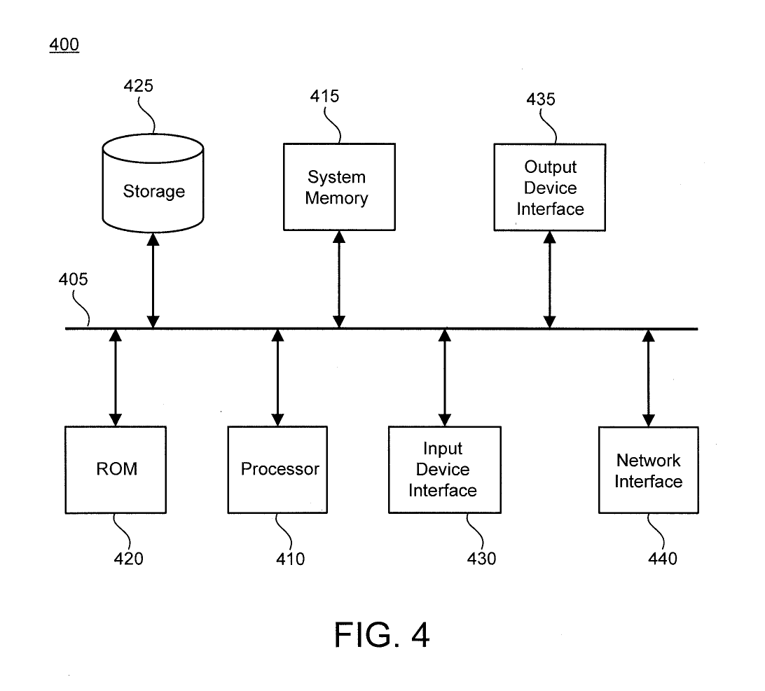

FIG. 4 conceptually illustrates an electronic system 400 with which some implementations of the subject technology are implemented. The electronic system 400 can be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only memory 420, a permanent storage device 425, an input device interface 430, an output device interface 435, and a network interface 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) can be a single processor or a multi-core processor in different implementations.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some implementations of the invention use a mass-storage device (such as a magnetic or optical disk and its corresponding disk drive) as the permanent storage device 425.

Other implementations use a removable storage device (such as a floppy disk, flash drive, and its corresponding disk drive) as the permanent storage device 425. Like the permanent storage device 425, the system memory 415 is a read-and-write memory device. However, unlike storage device 425, the system memory 415 is a volatile read-and-write memory, such a random access memory. The system memory 415 stores some of the instructions and data that the processor needs at runtime. In some implementations, the invention's processes are stored in the system memory 415, the permanent storage device 425, and/or the read-only memory 420. For example, the various memory units include instructions for processing multimedia items in accordance with some implementations. From these various memory units, the processing unit(s) 410 retrieves instructions to execute and data to process in order to execute the processes of some implementations.

The bus 405 also connects to the input and output device interfaces 430 and 435. The input device interface 430 enables the user to communicate information and select commands to the electronic system. Input devices used with input device interface 430 include, for example, alphanumeric keyboards and pointing devices (also called “cursor control devices”). Output device interfaces 435 enables, for example, the display of images generated by the electronic system 400. Output devices used with output device interface 435 include, for example, printers and display devices, such as cathode ray tubes (CRT) or liquid crystal displays (LCD). Some implementations include devices such as a touchscreen that functions as both input and output devices.

Finally, as shown in FIG. 4, bus 405 also couples electronic system 400 to a network (not shown) through a network interface 440. In this manner, the computer can be a part of a network of computers (such as a local area network (“LAN”), a wide area network (“WAN”), or an Intranet, or a network of networks, such as the Internet. Any or all components of electronic system 400 can be used in conjunction with the invention.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A machine-implemented method for displaying an advertisement in a supplemental display region in a display comprising:
obtaining, using one or more processors, primary content information from a first database;
providing, using the one or more processors, the primary content information for display in a primary content, display region;
providing, using the one or more processors, a first supplemental content display region and a second supplemental content display region, both of which are co-located within the primary content display region;
obtaining, using the one or more processors, advertisement information from a second database;
providing, using the one or more processors, the advertisement information for display in the first supplemental content display region;
accessing, using the one or more processors, a third database storing a plurality of textual quotations;
obtaining, using the one or more processors, information regarding a content of the primary content display region;
selecting, using the one or more processors, a textual quotation of the plurality of textual quotations based on a relevance of the textual quotation to the content, wherein the textual quotation has an initial ranking;
providing, using the one or more processors, the textual quotation for display in the second supplemental content display region, wherein the primary content information, the advertisement information and the textual quotation are displayed concurrently;
receiving, using the one or more processors, an indication that the textual quotation or the advertisement information was selected;
adjusting, using the one or more processors, the initial ranking of the textual quotation based on the indication; and
selecting, using the one or more processors, the textual quotation to be displayed within a third advertisement display region based on the ranking.

2. (canceled)

3. (canceled)

4. (canceled)

5. The method of claim 1, wherein the textual quotation is selected based on the advertisement information in addition to the relevance of the content.

6. The method of claim 1, further comprising:
extracting, using the one or more processors, the plurality of textual quotations from textual content of a plurality of books; and
filtering, using the one or more processors, the plurality of textual quotations to remove quotations with abusive content, wherein the textual quotation is obtained from the filtered plurality of textual quotations.

7. The method of claim 6, wherein providing the textual quotation for display comprises instructing, using the one or more processors, a web browser to provide a hyperlink to a website relating to a book in the plurality of books from which the textual quotation was extracted.

8. (canceled)

9. The method of claim 1, wherein the primary content display region includes a graphical map display of a geographic region.

10. The method of claim 9, further comprising:
selecting, using the one or more processors, the textual quotation from information identified as relevant to the geographic region.

11. The method of claim 1, further comprising:
obtaining, using the one or more processors, additional information; and
displaying, using the one or more processors, a predetermined time after the displaying of the textual quotation, the additional information in the second supplemental content display region.

12. The method of claim 1, wherein the relevance of the textual quotation corresponds to the textual quotation being dissimilar to the content.

13. (canceled)

14. A system for displaying advertisements, the system comprising:
one or more processors; and
a machine-readable medium comprising instructions stored therein, which when executed by the processors, cause the processors to perform operations comprising:
obtaining primary content information from a first database;
providing the primary content information to a user device;
receiving a first request from the user device for a first piece of supplemental content and a second request for a second piece of supplemental content for concurrent display within a supplemental display area which is within the primary content display area on the user device;
obtaining advertisement information from a second database;
providing the advertisement information to the user device in response to the first request;
accessing a third database storing plural pieces of data;
obtaining information regarding a content of the primary content display region;
selecting one or more of the plural pieces of data from the third database as additional information, based on a relevance of the additional information to the content, wherein the additional information has an initial ranking;
providing the additional information to the user device in response to the second request;
receiving, using the one or more processors, an indication from the user device that the additional information or the advertisement information was selected;
adjusting, using the one or more processors, the initial ranking of the additional information based on the indication; and
selecting, using the one or more processors, the additional information to be displayed within a third advertisement display region based on the ranking.

15. The system of claim 14, wherein the additional information is a textual quotation.

16. The system of claim 14, wherein the additional information is a video or image.

17. (canceled)

18. The system of claim 14, wherein the additional information is selected based on the advertisement information in addition to the relevance of the additional information to the content.

19. The system of claim 15, wherein the operations further comprise:
extracting a plurality of textual quotations from textual content of a plurality of books;
filtering the plurality of textual quotations to remove quotations with abusive content; and
storing the filtered plurality of textural quotations in the third database.

20. The system of claim 15, wherein the textual quotation comprises a hyperlink relating to a source from which the textual quotation was extracted.

21. (canceled)

22. The system of claim 14, wherein the primary content display area includes a graphical map display of a geographic region.

23. The system of claim 22, wherein the operations further comprise:
selecting the additional information from pieces of additional information identified as relevant to the geographic region.

24. The system of claim 15, wherein the operations further comprise:
providing a second textual quotation obtained from the third database to the user device after a predetermined time to replace the textual quotation provided to the user device.

25. The system of claim 14, wherein the relevance of the additional information corresponds to the additional information being dissimilar to the content.

26. (canceled)

27. A non-transitory machine-readable medium comprising instructions stored therein, which when executed by a machine, cause the machine to perform operations comprising:
obtaining primary content information from a first database;
providing the primary content information for display in a primary content display region;
receiving a first request associated with a first supplemental content display region and a second request associated with a second supplemental content display region for concurrent display within a supplemental display area which is within the primary content display area on a user device;
obtaining advertisement information from a second database;
providing the advertisement information to the user device in response to the first request;
accessing a plurality of textual quotations from a third database storing plural pieces of data;
obtaining information regarding a content of the primary content display region;
selecting a textual quotation of the plurality of textual quotations from the third database based on a relevance of the textual quotations to the content, wherein the textual quotation has an initial ranking;
providing the textual quotation to the user device in response to the second request;
receiving an indication that the textual quotation or the advertisement information was selected;
adjusting the initial ranking of the textual quotation based on the indication; and
selecting the textual quotation to be displayed within a third advertisement display region based on the ranking.

28. (canceled)

29. (canceled)

30. (canceled)

31. The machine-readable medium of claim 27, wherein the textual quotation is selected based on the advertisement information in addition to the relevance of the textual quotation to the content.

32. The machine-readable medium of claim 27, wherein the operations further comprise:
extracting the plurality of textual quotations from textual content of a plurality of books; and
filtering the plurality of textual quotations to remove quotations with abusive content,
wherein the textual quotation is obtained from the filtered plurality of textual quotations.

33. The machine-readable medium of claim 27, wherein the textual quotation comprises a hyperlink relating to a source from which the textual quotation was extracted.

34. (canceled)

35. The machine-readable medium of claim 27, wherein the primary content display area includes a graphical map display of a geographic region.

36. The machine-readable medium of claim 35, the operations further comprising:
selecting the textual quotation from pieces of information identified as relevant to the geographic region.

37. The machine-readable medium of claim 27, the operations further comprising:
Obtaining additional information; and
providing the additional information to the user device after a predetermined time for display.

38. The machine-readable medium of claim 27, wherein the relevance of the textual quotation corresponds to the textual quotation being dissimilar to the content.

39. (canceled)
